(19) United States
(12) Patent Application Publication
(10) Pub. No.: US 2026/0266435 A1
(43) Pub. Date: Sep. 10, 2026

(54) DECORATIVE LIGHTING ASSEMBLY AND SYSTEM FOR VERTICAL STRUCTURES, SUCH AS LAMP POSTS, POLES AND TREES

(71) Applicant: Stanley J Lech, JR., Davie, FL (US)

(72) Inventor: Stanley J Lech, JR., Davie, FL (US)

(21) Appl. No.: 19/547,661

(22) Filed: Feb. 23, 2026

Related U.S. Application Data
(63) Continuation-in-part of application No. 18/445,780, filed on Jan. 29, 2024, now Pat. No. 12,560,289.

(51) Int. Cl. F21S 2/00; F21S 4/24; F21V 21/22; F21V 23/04; F21W 121/04; F21Y 105/18; F21Y 115/10

(52) U.S. Cl. CPC F21S 2/005; F21S 4/24; F21V 21/22; F21V 23/0464; F21V 23/0471; F21W 2121/04; F21Y 2105/18; F21Y 2115/10

(57) ABSTRACT

A decorative lighting assembly for vertical structures, e.g. posts and trees, includes: a plurality of stackable grid members, each a semi-flexible sheet having a top, a bottom and at least two sides, having sufficient flexibility to wrap around the vertical structure and having a maximum width of x and having a rigid vertical section of the sheet less than width x, the semi-flexible sheet, each of the grid members having an attachment mechanism at the top and an attachment mechanism at the bottom to vertically connect each of the grid members to one another; at least one decorative lighting member that is selected from being permanently attached to and being removably attached to the grid member, the at least one decorative lighting member having a plurality of decorative lights electrically connected to one another, and having a power source connection for the decorative lights.

### REFERENCE TO RELATED APPLICATIONS

This application is a continuation-in-part of U.S. Utility patent application Ser. No. 18/445,780, Docket SJL-110A, titled “Decorative Lighting Assembly for Vertical Structures” filed on Jan. 29, 2024 by the same inventor herein, each priority application is hereby incorporated by reference in its entirety.

### BACKGROUND OF INVENTION

### a. Field of Invention

The present invention relates to installation and removal of seasonal decorative lighting as applied to tall vertical structures such as lamp posts, poles, trees and any other such structures to which users may desire to temporarily install decorative lighting. Two such examples are: decorative lights attached to palm trees, coconut trees and other trees with high, extended trunks; and government installed Christmas lighting on Main Street lamp posts. Historically, such installations involve the dangerous use of ladders (leaning against a structure that has a smaller width than the ladder), or expensive and awkward “cherry picker” elevated baskets, or as in the case of one municipality, dangerously driving from lamp post to lamp post with a small ladder on the bed of a pick-up truck to wrap lighting around the post. The present invention objectives include eliminating such dangers and making installation easy from the ground. The present invention involves decorative lighting assemblies that include stackable, semi-flexible grid members that wrap around and glide up vertical structures, and each grid member includes a stiffing section, i.e., a rigid vertical section, to maintain its structural integrity when it has been installed on a post or tree or other vertically elongated structure. The present invention decorative lighting assemblies also include at least one decorative lighting member that is selected from being permanently attached to, and being removably attached to, one or more grid members. Each decorative lighting member has a plurality of decorative lights electrically connected to one another, and has a power source connection to electrically connected decorative lights such as AC, DC, or battery or solar power.

### b. Description of Related Art

The following patents are representative of the field pertaining to the present invention:
U.S. Pat. No. 11,723,425 B2 to Pengov describes decorative systems that include an elongated decorative element and associated methods of manufacture and use are described. An example decorative system has a frame and an elongated decorative element attached to the frame. The frame has a first end, a second end, a length, and a main body that defines a slot and a central passageway. The slot provides access to the central passageway. The frame is moveable between a first configuration and a second configuration. The slot has a first width when the frame is in the first configuration and a second width when the frame is in the second configuration. The second width is greater than the first width. The first elongated decorative element has a first end, a second end, and a length. The length of the first elongated decorative element is greater than the length of the frame.
U.S. Pat. No. 10,641,470 B1 to Smyth describes a decorative lighting device and process for mounting method the lighting device on curved or cylindrical surfaces or support structures, such as tree trunks, columns and poles, the lighting device including a system of light strands mounted to at least two brackets at opposite ends of the light strands, and preferably multiple intermediate brackets along the length of the strands between the end brackets, wherein the strands are connected to the brackets by fasteners, such as ties, tie wraps or staples with a first predetermined distance between the fasteners and a second predetermined distance between the light strands, and the brackets are positioned laterally with respect to the strands and spaced apart a third predetermined distance. The brackets may be made of plastic or wood and have predetermined dimensions. The light strands include a plurality of light sources, preferably LED's, that may be a single color or different colors.
U.S. Pat. No. 6,224,231 B1 to Personius describes a festive decorative lighting system for trees which features a collar that encompasses a circular power bus that is connected to a plurality of light strings that protrude through the sides of the collar and radially descend down the sides of the tree to positions remote from the collar. The user places the collar onto the crown of the tree by using a telescopic pole with a hook that reversibly engages a hoop attached to the top of the collar.
U.S. Pat. No. 6,062,701 to Hines describes a telescoping, outdoor, lighted, Christmas tree exhibit, which at night will simulate a lighted Christmas tree. The Christmas tree exhibit comprises a plurality of concentric hoops, populated with Christmas lights. The hoops are each of decreasing diameter that are sequentially interconnected by a plurality of concentric non stretching, flexible plastic bands, each hoop decreasing in size at the same rate as the hoop before it, with the largest-diameter hoop at the bottom of the Christmas tree exhibit and the smallest-diameter hoop at the top of the Christmas tree exhibit, when fully extended, a conical, tree-shaped appearance is obtained. Preceding the uppermost hoop is a top disk that is connected to the top end of the non stretching, flexible plastic bands. The top disk is supported by an adjustable, collapsible center pole. The bottom end of the non stretching, flexible plastic bands are anchored at the bottom of Christmas tree exhibit, so that when the non stretching, flexible plastic bands are fully extended and pulled taut, the hoops of the tree are completely suspended off the ground and the Christmas tree is standing. The tree is light weight and wind resistant. When disassembled, the hoops rest one inside the other, not touching each other, allowing the lights to stay attached to the hoops while in storage and preventing the breakage of bulbs and entangling of lights, resulting in a quick pop-up installation, and quick disassembly with minimal storage space required.
U.S. Pat. No. 5,639,157 to Yeh describes a decorative light string includes a multiplicity of illuminators; a multiplicity of light output transducers, each of the illuminators receiving light from at least one corresponding light output transducer; a wire harness connected to the illuminators, the harness having a principal portion, a multiplicity of feeder members extending from spaced feeder locations on the principal portion to respective illuminators for permitting the illuminators to be located at respective distances from the principal portion, the distances being greater than the spacing between the feeder locations, at least one of the illuminators including a corresponding one of the light output transducers, the corresponding feeder including a pair of conductors extending from the corresponding feeder location of the harness, the pair of conductors being connected to the transducer; and an AC powered control circuit connected to a plurality of circuit paths of the wire harness, the control circuit being capable of sequentially driving the circuit paths for activating corresponding subsets of the light output transducers, the light output transducers of each circuit path being series-connected, adjacent ones of the light output transducers being in different ones of the circuit paths.
U.S. Pat. No. 4,852,832 to Delaney describes a novel decorative light holder which includes means for retaining separate lights and intermediate wiring along straight and curvilinear paths including paths perpendicular to each other; and includes contact adhesive means to permit easy attachment on walls or other structures, such as window frames or adjacent interior or exterior wall structures.
U.S. Design Pat. No. D876,275 S to Huang illustrates a design for a lighted palm tree assembly.
U.S. Patent Application Publication No. 2020/0208794 to Strange describes a lighting device which can be wrapped or attached securely around a trunk or branch of a tree or around a column, beam, pole, an arch, or other object around which the lighting device can be attached. The device includes a light apparatus having a string of lights arranged into a mesh of lights or a preformed mesh of lights, a first cord connected across a top end of the light apparatus and having a hook on each end, and at least a second cord connected across a bottom end of the light apparatus and also having a hook on each end.
U.S. Patent Application Publication No. 2022/0412518 A1 to Singh describes a banner assembly, for example, a banner assembly having a light-emitting diode (LED) light network arranged in a pattern of a national flag thereby illuminating the national flag for display. The banner assembly herein comprises an LED light network having LED lights arranged in a pattern of a national flag, and a plurality of detachable rods attached to the LED light network by one or more connectors.

U.S. Patent Application Publication No. 2007/0041179 A1 to Barthelmess describes an artificial palm tree assembly for insertion into a table, preferably a patio table, is provided. The artificial palm tree assembly comprises a palm head comprising a crown element and a plurality of tree elements attached to the crown element of the palm head. Each of the tree elements comprises a branch having a plurality of artificial palm tree leaves thereon. In addition, the artificial palm assembly further comprises a trunk element adapted for installation through an opening in the top of the table. The palm head connects to the trunk element via an attachment formed between the bottom area of the crown element and the top end of the trunk element. Moreover, artificial palm assembly preferably further comprises a base portion for providing support for the palm head and the trunk element of the palm tree assembly installed within the patio table.
U.S. Patent Application Publication No. 2001/0025393 A1 to Nicolette describes a decorating and cleaning product which uses a unique latch attachment designed to efficiently hang decorative holiday items such as strings of Xmas Lights in high trees and other places with the use of an 11′ foot 3 locking telescopic pole and the screw on latch. This allows for the elimination of a ladder which can be a safety hazard, plus it expands holiday decorating through the use of the pole and latch attachment. Working in sync with the decorative end of the latch, is the open end gutter cleaning brush which depresses into the gutter while pulling the attached rope which at the same time opens the opposite decorative end to pick up small limbs, twigs and other items to discard. The secondary cleaning attachment is designed to screw into the same 11-foot 3 section telescopic pole, which allows for the cleaning of high windows, walls and ceilings. This invention is made of rubber, soft cloth, plastic, wood and fiberglass making it safe, light and flexible and most importantly it does not conduct electrical current, so when using to hang strings of xmas lights, it can be considered electrically shock proof.

Notwithstanding the prior art, the present invention is neither taught nor rendered obvious thereby.

### SUMMARY OF INVENTION

The present invention relates to decorative lighting assemblies for vertical structures, such as lampposts, poles and trees, that eliminates the need for ladders, or bucket trucks or other elevating devices and allows users to stack these assemblies to high positions, such as ten, fifteen, twenty feet or more, without leaving ground level. This present invention assembly includes: a) at least one grid member, the grid member being a semi-flexible sheet having a top, a bottom and at least two sides and having a maximum width of x and having a vertical section of the sheet less than width x wherein the vertical section is a rigid vertical section, the semi-flexible sheet having sufficient flexibility to wrap around the vertical structure; and b) at least one decorative lighting member that is selected from being permanently attached to and being removably attached to, the at least one grid member, the at least one decorative lighting member having a plurality of decorative lights electrically connected to one another, and having a power source connection to the electrically connected decorative lights.

In some present invention embodiments, the at least one grid member is at least one semi-flexible sheet selected from the group consisting of a continuous sheet and broken sheet. By “broken” is meant having slots, openings, orifices or cut-outs. In some present invention embodiments, the broken sheet is selected from the group consisting of a mesh, a randomly orificed sheet and a symmetrically orificed sheet.

In some embodiments of the present invention decorative lighting assemblies for vertical structures, the rigid vertical section is an integral section of the sheet that is a unistructurally formed sheet. In some of these embodiments, the integral section is a thicker section and the sheet includes at least one thinner, flexible section. Alternatively, the sheet could be of the same flexible thickness, but have embedded rod or rods or other stiffening component(s). In other embodiments of the present invention decorative lighting assemblies for vertical structures, the rigid vertical section is a separately attached section. This could be glued, heat sealed, sleeved or otherwise attached to a main sheet. In some embodiments, the rigid vertical section is a rigid vertical section selected from the group consisting of an elongated flat piece, a rod, and a spine, or multiples or combinations thereof.

In some preferred embodiments of the present invention decorative lighting assemblies for vertical structures, the at least one grid member is a flat sheet with a plurality of vertically foldable hinges to enable flat storage and to enable flexible wrapping about the vertical structure. This is most preferred as storage in a flat position is most efficient. Typically, there will be multiple section panels with hinge folds in-between.

Further, in the present invention, the at least one grid member includes attachment mechanisms for receiving and holding the at least one decorative lighting member to it. The power source connection in the present invention is for connection to power sources selected from the group consisting of an AC power source a DC power source and a battery power source.

In alternative embodiments, the decorative lighting assembly for vertical structures includes a plurality of stackable grid members, each of the grid members being a semi-flexible sheet having a top, a bottom and at least two sides and having a maximum width of x and having a vertical section of the sheet less than width x wherein the vertical section is a rigid vertical section, the semi-flexible sheet having sufficient flexibility to wrap around the vertical structure, each of the grid members having an attachment mechanism at the top and an attachment mechanism at the bottom to vertically connect each of the grid members to one another, as well as the decorative lighting member and all of the other features described above.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a block diagram showing some of the features and options of the present invention decorative light assemblies;

FIG. 2 illustrates another block diagram showing more details of the present invention decorative light assemblies;

FIG. 3 shows a top view of the grid member of the present invention in which the vertical rigid section is a unistructurally formed grid member;

FIG. 4 shows a side view of the grid member of the present invention shown in FIG. 3;

FIG. 5 shows a top view of the present invention assembly with the grid member similar to that shown in FIGS. 3 and 4 and including a decorative lighting member that is mounted from the inside;

FIG. 6 shows a top view of the assembly shown in FIG. 5, but with open ends spread to wrap around the palm tree shown in this Figure;

FIG. 7 shows a top view of the assembly shown in FIGS. 5 and 6, now fully attached to the palm tree, and FIG. 8 shows a side view thereof, with four different assemblies stack upon each other and connected to each other;

FIG. 9 shows a side view of an alternative present invention assembly grid member with multiple thick sections and thin hinge sections for flat storage and for wrapping around a vertical structure;

FIG. 10 shows a top view of the present invention decorative light assembly grid member shown in FIG. 9;

FIG. 11 shows a top view of a present invention decorative light assembly that includes the grid member of FIGS. 9 and 10 and now including an externally attached lighting member, and FIG. 12 shows that assembly attached to a lamp post with a second, stacked present invention decorative light assembly;

FIG. 13 shows a top view of the present invention assembly similar to that shown in FIG. 5 in which the decorative lighting member includes a wireless microcontroller connected to an input device for controlling the decorative lighting member;

FIG. 14 shows the decorative light assembly and systems as in FIG. 12 additionally supporting light and photos sensors, speakers, and an outdoor laser light projector;

FIG. 15 shows a snap-joint connection for secure non-lighting attachments such as a wreath (shown in a side view) to the grid members;

FIG. 16a shows a side view of an alternative present invention assembly grid member with multiple thick sections and thin hinge sections for flat storage and for wrapping around a vertical structure as in FIG. 9 wherein in addition the thick sections are expandable;

FIG. 16b shows a top view of the present invention decorative light assembly grid member shown in FIG. 16a;

FIG. 17a shows a top view of the present invention assembly with the grid member similar to that shown in FIG. 5 wherein in addition the outer ends of the grid member are telescoping and in a telescoped position;

FIG. 17b shows a top view of the present invention assembly as in FIG. 17a wherein the outer ends of the grid member are in an expanded position;

FIG. 18 shows a top view of an embodiment of the present invention decorative light assembly as shown in FIG. 11 in addition including atmospheric misting channels mounted to the grid member with a fluid delivery system.

FIG. 19 shows a side view of an embodiment of the present invention decorative light assembly wherein flexible thin-film photovoltaic cells are positioned on a front surface of the grid members.

FIG. 20 is a diagrammatic view of another embodiment of the flexible grid members wherein a portion is comprised of a conventional material and another portion is comprised of an SMP material.

### DETAILED DESCRIPTION OF THE EMBODIMENTS

The present invention decorative lighting assembly is beneficially utilized by installing on a vertical structure and stacking two or more assemblies so that they extend upwardly beyond human reach, and are connected to one another in a stacked formation to maintain stacking integrity. Assembly is used herein to reference a combination of a grid member and a lighting member, whereas system is used to mean a plurality of stacked, connected assemblies. Thus, a user will attach the lighting member to the grid member (or it will be purchased already assembled) to create an assembly. The user will then wrap the first assembly around the tree or pole or other vertical structure, assure the assembly is attached to the vertical structure, push up that first assembly and then similarly install a second assembly below the first and attach the two. Where there are plug powering arrangements, the plugs must be plugged in. The process is repeated for a third, fourth, etc. assembly stackings, to achieve the desired height of the lighting without the user having to leave ground level. Thus, the stackable and connectable assemblies create an illumination system that allows one individual to decorate high vertical and elevated surfaces such as trees, poles, and lamp posts without the need of a ladder or lift equipment/aids. The system allows physically fit and physically limited and elderly individuals the ability to decorate surfaces beyond their natural reach and without the need of a ladder, lift equipment such as a bucket lift, cherry picker, boom or elevated platforms.

The system of stackable and connectable decorative light assemblies includes the basic support flexible grid members and the decorative lighting members. The grid member is made of flexible vertical, horizontal, diagonal or otherwise shaped members. The members can vary in structural rigidity to allow bending around surfaces and/or supporting the weight of the system to avoid bowing or collapse. Each grid member may be in a shape that can be easily stored as a flat mat, such as a square or rectangle. This ensures minimum storage space for the system when not in use. The grids are supplied in various heights and lengths so that they can be applied to different size and diameter trees, poles and posts, or be significantly adjustable with lengthy attachment components. In some embodiments, the grids are self-centering on the tree due to flexible spacer blocks that provide a consistent distance from the tree, pole or post and the bend in place grid. In other embodiments, spacers are not used.

When ready to use, each individual grid and light assembly is taken from its storage case. The first assembly can be bent into or otherwise formed or already shaped in a cylindrical or polygonal shape around trees, poles and posts to cover the surface. Upon completing the installation over the surface of the tree (or other vertical structure), the first grid member and lighting assembly is then locked into place to form a self-supporting wrap, such as a cylinder or other footprint shape, capable of accepting and supporting additional grids above or below it. Ideally, the first assembly is put in place around the tree, pole or post and is pushed up vertically. Then a second grid is then placed underneath the first assembly. The first and second assembly are then connected to allow the flow of electricity between each assembly, or in the case of wirelessly controlled battery powered assembly units, electrical connection between assemblies is unnecessary. This stacking process continues until the desired area of the tree, post or pole is covered with illumination, or as a user may otherwise desire. Such a system allows for fast decoration of a vertical structure by one person. The removal process is the reverse operation of installation, with gravity assisting in the process.

Illuminating surfaces such as homes, trees, poles and lamp posts are very popular practices during national and religious holidays. The most popular method used to illuminate vertical and elevated surfaces such as poles, trees and lamp posts are LED and incandescent lights bulbs on a string and/or stretchable meshes with lights. These lights are typically wound around the trees, poles and posts to cover the surfaces. Such operations can take hours to apply the illumination to the surfaces and require a ladder or lift equipment depending upon the height of the surface needing decoration. The mesh lights fit snugly around the tree, pole or post and require ladders and/or lift equipment both to decorate surfaces that are beyond reach and to remove the lighting when done. In addition, these meshes cannot be moved vertically by the application of the second layer below it. Therefore, they lack the “push along”, stackable feature of the present invention and do not allow the illumination to gain height as the application process continues. Typically, 6-8 feet is the maximum height that can be reached by an individual without lift aids. Many people and municipalities enjoy decorating their homes, property and towns with lights for various holidays and celebrations. However, cost, dangers of falling, storage of the illumination when not in use, and need to use rental lifts or vehicles with bucket lifts are significant barriers to installing such illuminations. The safety aspect alone cannot be understated as there are approximately 164,000 emergency room visits per year for individuals falling off ladders and ladder falls are associated with approximately 300 deaths per year. The present invention completely eliminates those risks.

The present invention illumination assemblies that are stackable, modular, adjustable, interconnectable and flexible, may contain multiple illumination features such as LED and incandescent lights which can be energized by AC or DC power. These lights exhibit colors of the visible light spectrum and may have the added feature of flashing and blinking beyond the always on lighted setting. The present invention assemblies are self-supporting and allow vertical illumination on trees, poles and posts up to vertical heights of 20, 50 and even 100 vertical feet. These may be sold in packs of multiple assemblies, which may be the same height or varying heights, such as 4 five foot high assemblies or 3 five foot high plus 1 two foot high assemblies per kit. The lighting members may be included or purchased separately. The Illuminated grid is made of materials resistant to cold, heat and moisture, thus being able to operate safely in all climates and bad weather. The illuminated grid system can be customized by the size/diameter of the surface to cover, for instance the diameter of a tree, pole or post. One system can be made up of various sizes to account for irregular diameters such as a palm tree. The grid members may contain a self-centering feature which allows for equidistant positioning around a tree, pole or post. The centering is achieved via flexible extensions on the inside surface of the grid that interfaces with the tree, pole or post. The illuminated grid member may contain an anti-slip down feature to allow the grid to be placed on the tree, pole or post and shifted up without slipping back down. This allows the placement of another grid beneath it without having to hold the upper assembly. The illuminated grids use temporary locking clips or mechanisms to keep the grids in a cylindrical shape during installation.

Referring now in detail to the drawings wherein like reference numerals designate corresponding parts throughout the several views, various embodiments of the present invention are shown. By way of definition, the terms “sheet and “grid” refer to supporting members that stack and hold lighting members in place. The sheet may be flat or not, may have orifices or not and may even be grids such as plastic or metal lattices and links, similar to link fences, without exceeding the scope of ”sheets“ and ”grids“.

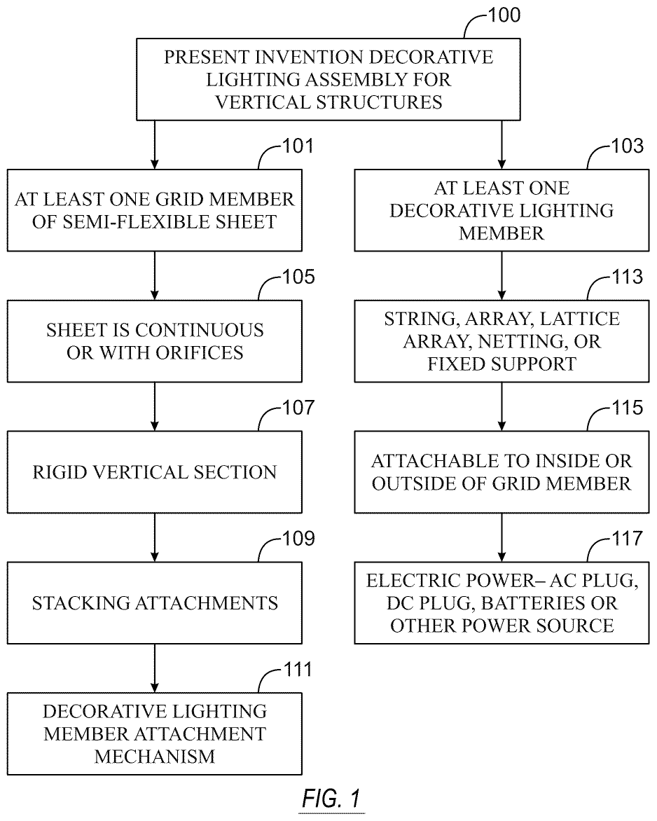

FIG. 1 is a block diagram showing some of the features and options of the present invention decorative light assemblies. Block 100 sets out the invention; blocks 101 and 103 define the two primary components of present invention assemblies-at least one grid member of semi-flexible sheet; and at least one decorative lighting member. Referring to more details shown below block 101, block 105 indicates that the sheet may be continuous (no orifices) or with orifices (which may be symmetrical or non-symmetrical), and block 107 indicates that there is a rigid vertical section (to aid in stacking and to avoid flopping or disconnecting from the vertical structure to which it will be attached). Block 109 shows stacking attachments. These are located at the bottom or the top or both bottom and top of the grid members so that the stacked grid members may be attached to one another. In some embodiments, the side ends also have attachment mechanisms to connect an assembly to itself (to keep it tightly positioned around the vertical structure, e.g., an elongated tree trunk). As shown in block 111, there is a decorative lighting member attachment mechanism on the grid member for attaching the lighting member. This could simply be orifices into which bulb holders and bulbs are inserted (as in FIGS. 5, 6 and 7 below) or snaps, or open loops for pass-through, or Velcro strips (aka loops and hooks), tea cup hooks or any other known attachment mechanisms. As lighting is common and on the market in strips, strings and netting, it is preferred to have these attachments on the grid members. However, they may instead, or in addition, be on the lighting members, without exceeding the scope of the present invention. On the right side of FIG. 1, below block 103 are additional features of the lighting members. Block 113 indicates that the lighting member may be a string of lights, a lattice array, netting, or lights on a fixed support. Block 115 indicates that the lighting member may be attached to the inside or the outside of the grid member. If on the inside, then the grim member must have orifices or be transparent or translucent, at least in part for the lights to show through. Block 117 indicates possible power sources for the lighting member.

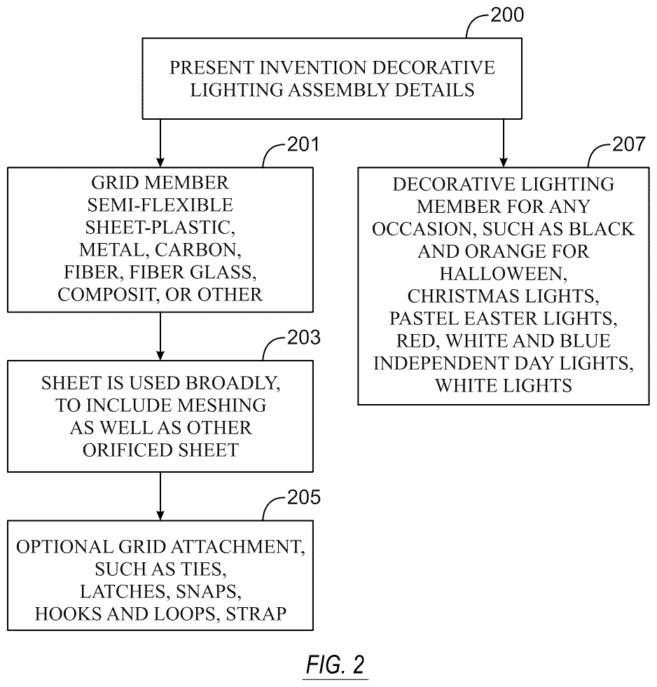

FIG. 2 illustrates another block diagram showing more details of the present invention decorative light assemblies, block 200. Block 201 indicates the various materials that may be used to create the grid members; block 203 supports a broad interpretation of the word “sheet” and block 205 illustrates examples of attachments used to attach a grid member to another grid member in stacking as well as to itself for secure closure about a vertical structure (tree, for example). Block 207 indicates that the lighting member may be customized for any occasion.

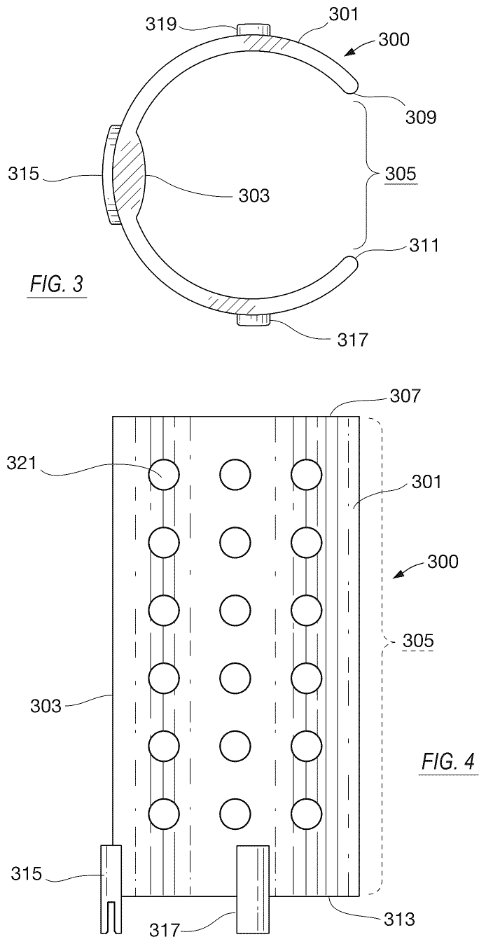

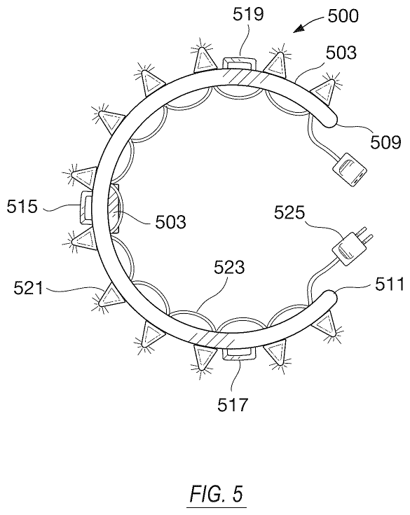

FIG. 3 shows a top view of the grid member 300 of the present invention, and FIG. 4 shows a side view of the same grid member 300. Both Figures are now discussed concurrently. Grid member 300 has a vertical rigid section 303 that is unistructurally formed as part of grid member open flexible loop 301, made of plastic material (such as PVC, polyethylene-propylene blend), fiber glass, carbon fiber or otherwise, with opening 305, and stacking attachments 315, 317 and 319. The loop ends (side walls) are shown as ends 309 and 311. The top is shown as top 307 and the bottom is bottom 313. This grid member 300 has a plurality of orifices, such as orifice 321, which may be used to pass connectors therethrough for lighting attachment, but are more readily used for inside light mounting, with the lights snapped into the orifices so as to protrude to the outside, for beautiful decorative occasion lighting. Attachment mechanisms, i.e., stacking attachments 315, 317 and 319 have clothespin-like slits for assembly interconnection.

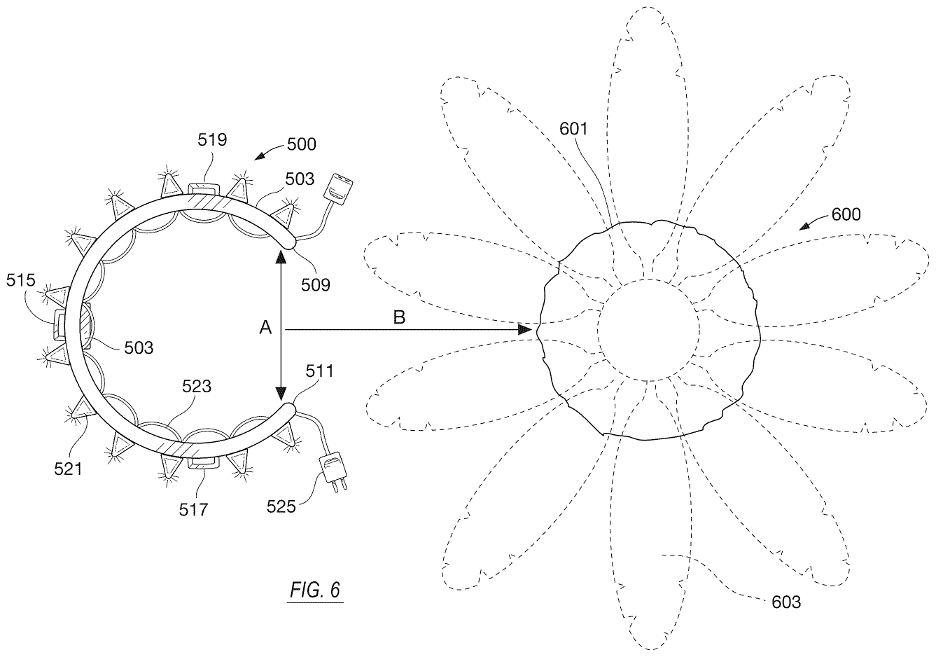

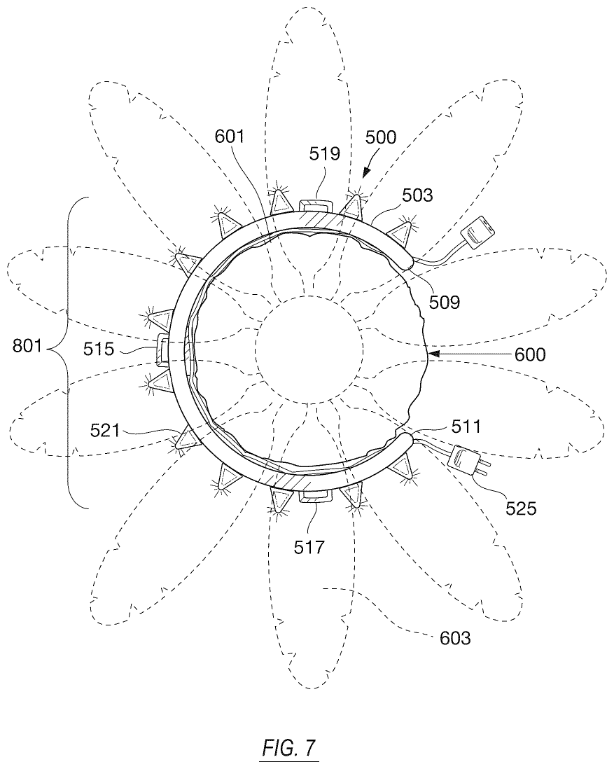

FIG. 5 shows a top view of the present invention assembly with the grid member 500 similar to that shown in FIGS. 3 and 4, but with a separate attached vertical stiffening board 503 and including a decorative lighting member 523 that is mounted to grid member 500 from the inside. Grid member 500 has a natural “living spring” C-shaped footprint that can be spread open at ends 509 and 511 and then released to “spring” back to its original position, around a tree or post. It is a complete single assembly and the grid member 500 includes attachment clips 515, 517 and 519. The lighting member 523 here is a string of Christmas lights with bulbs and bulb receivers, such as bulb 521, passing through the orifices of grid member 500. These strings have male and female connecting plugs, such as plug 525 for powering the lights. FIG. 6 shows a top view of the assembly shown in FIG. 5, but with open ends 509 and 511 spread to wrap around the palm tree 600 (with very tall trunk 601 and palm leaves such as 603, shown in this Figure. The ends are spread open along the path of line A and then while open, assembly 801 is moved onto tree 600 and the ends are released. FIG. 7 shows a top view of assembly 801 shown in FIGS. 5 and 6, now fully attached to the palm tree 600, and FIG. 8 shows a side view thereof, with four different assemblies stacked upon each other and connected to each other. Here, palm tree 600 has assembly 801 positioned at the top, and below it is connected to assembly 803. Assembly 803 is in turn, connected below to assembly 805. Likewise, assembly 805 is connected below to assembly 807. These four assemblies connected create system 800. Assuming each assembly is 5 feet tall, the user has safely achieved a twenty-foot tall, secured installation without leaving the ground, using the stacking methods described above.

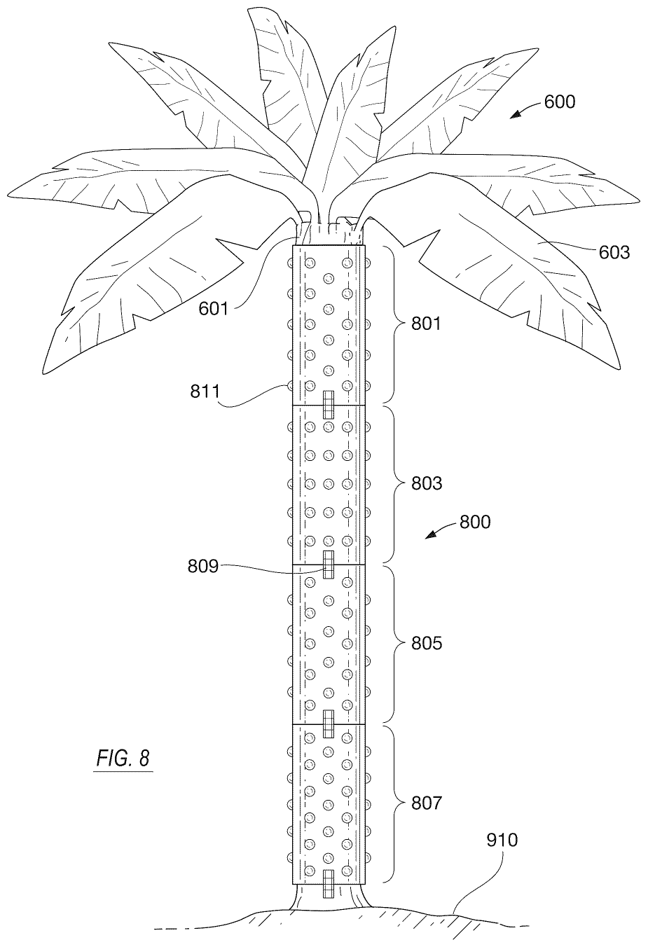

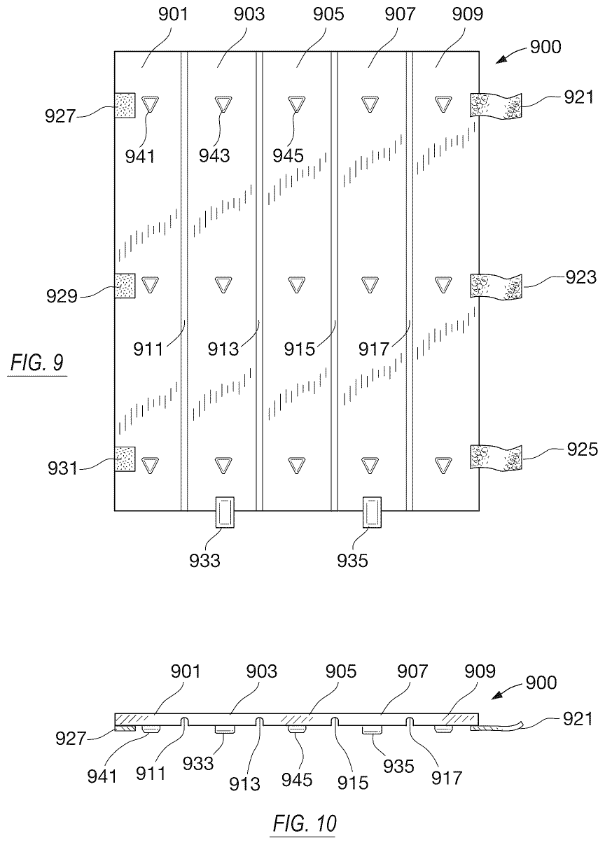

FIGS. 9, 10, 11 and 12 are now discussed collectively. FIG. 9 shows a side view of an alternative present invention assembly grid member 900 with multiple thick sections 901, 903, 905, 907 and 909, and thin hinge sections 911, 913, 915 and 917, for flat storage and for wrapping around a vertical structure. There are also self-connecting hook and loop connectors 921, 923, 925, 927, 929 and 931, as well as bottom clips 933 and 935 for attachment to a below positioned similar grid member. There are multiple light fixture member hooks 941, 943, and 945 for attachment to the grid member 900. FIG. 10 shows a top view of the present invention decorative light assembly grid member 900 shown in FIG. 9.

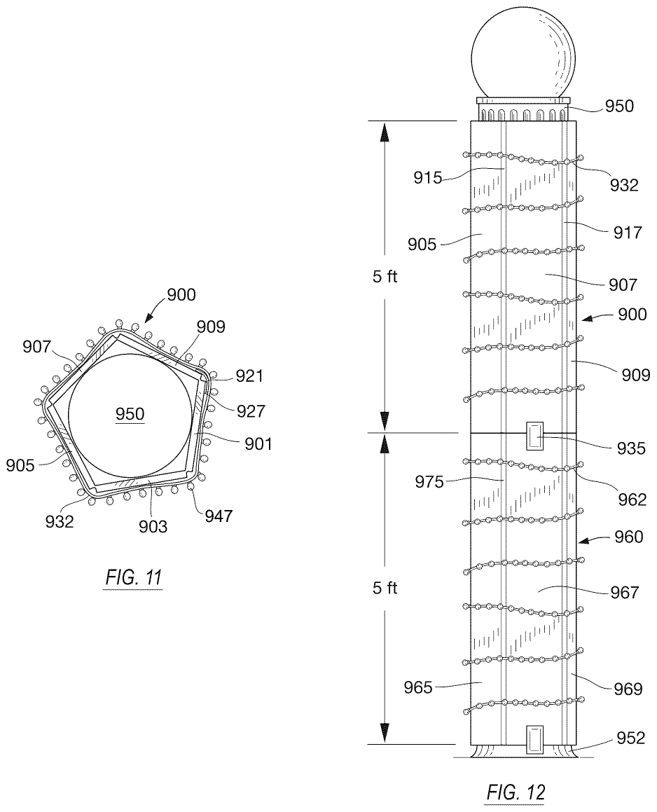

FIG. 11 shows a top view of a present invention decorative light assembly that includes the grid member 900 of FIGS. 9 and 10 and now includes externally attached lighting member 932 with lights, such as light 947. FIG. 12 shows that assembly attached to the upper section of lamp post 950, with lamp post base 952 that is flared and acts as a bottom stop for the assemblies. There is a second, stacked present invention decorative light assembly below the grid member 900 that includes grid member 960 and thick section panels 965, 967 and 969, with thin vertical hinge folds, such as fold 975, there between. Grid member 960 has lighting string 962 attached thereto.

In other embodiments, the present invention decorative lighting assembly and system further comprises arrangements for enabling more advanced and precise control of the light members as well as for providing dynamic and customizable lighting displays and effects. This may be accomplished with either a single decorative lighting assembly, i.e., a single lighting member including a plurality of individual lights or luminaires attached to a single grid member, or a decorative lighting system created by vertically stacking and connecting the grid members of two or more decorative lighting assemblies, or even an overall illumination system including multiple decorative lighting systems each consisting of two or more stacked decorative lighting assemblies, secured to different vertical structures in an outdoor plaza, shopping area, courtyard, or the like. In some embodiments, the lighting member of a decorative light assembly is an LED light string containing multiple LED lights and an LED strip light controller which enables programming and controlling of the LED lights or LEDs. The LED controller preferably is connected to or includes a wireless transceiver device which enables wireless control of the LED lights.

It will be understood that the LED light controller may be of different types depending upon the type of LED light string being utilized and the particular control needs. For example, the LED controller may be a single-color LED controller where the LED bulbs are single color LED bulbs (either all the same color or a variety of different colors) and basic on/off and dimming functionality is required. In other embodiments, the LED controller may be a multi-color LED controller. Where the LEDs are multi-color RGB LED bulbs, an RGB LED controller controls the red, blue and green channels to create a variety of colors but without controlling individual LEDs. Where the LEDs are RGBW LED bulbs, the LED controller may be an RGBW LED controller, which adds a white channel to enable creation of pure white light and enhanced color accuracy. If the LED light strip is an RGBIC LED light strip, an RGBIC light controller is used to control individual LEDs, making it possible to create advanced lighting effects, including dynamic color changes and complex patterns. The LED controller may also be an RGBWW LED controller, which allows for warm and cool white colors and allows for more realistic replication of natural light. RGBIC and RGBWW LED controllers allow for generation of a virtually infinite full spectrum of colors and color changing effects.

In some embodiments, the LED controller wireless transceiver device may comprise a Bluetooth LED controller using Bluetooth low energy technology, which enables simple and low-cost wireless control of the LED lights from Bluetooth-enabled devices such as smartphones within a limited range. In some embodiments, the LED controller may also be a WiFi LED controller which connects to standard WiFi router networks and devices and enables lighting control via apps, browsers and voice assistants. In some embodiments, the LED controller may be a Zigbee LED controller which uses the Zigbee wireless protocol, which is specifically designed for automation devices and forms a mesh network between devices, provides very long range mesh capabilities and robustness, and is optimal for expansive outdoor lighting control across larger spaces designed for large-scale lighting networks. Zigbee requires separate hubs/gateways to connect devices. In some embodiments, the LED controller may also be an SPI controller wherein the LED light strip is a digitally addressable LED light strip that allows control of individual LED modules (e.g., WS2812B, TM1814) and enables advanced pixel chasing and custom animations. In some embodiments, the LED controller may also include an RF wireless dimmable driver power supply unit which uses RF signals to communicate with compatible LED drivers for remote dimming control. In some embodiments, the controller may be a DMX controller utilizing advanced DMX-512 digital lighting protocol for precise lighting control allowing for synchronized shows, dimming, and color mixing. In some embodiments, the controller may also be a Tuya WiFi Bluetooth smart controller device which allows for wireless control of LED lighting from a smartphone and tables using WiFi or Bluetooth, while also allowing voice control and integration with smart home systems and assistants like Amazon Alexa and Google Assistant. Thus, the wireless transceiver device will be configured to wirelessly connect the LED light string to a user interface or hand control via a suitable wireless communications technology (e.g., Bluetooth Low Energy technology, Wi-Fi, RF, or Matter protocol, e.g. Alexa, Google Home) enabling the LED controller to receive input from and send control commands to the LEDs.

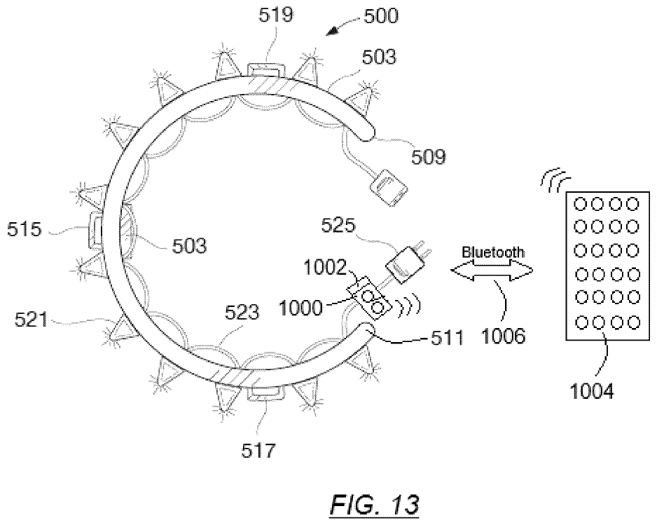

In some embodiments, the LED controller comprises an Integrated Control Module (“ICM”) connected to the LED light string. The LED controller will establish communications with a input device/hand control which typically contains various buttons or dials either in physical form as in FIG. 13 or an app to facilitate controlling the LEDs. The LED controller may include software making the controller programmable for creating customizable animations. The ICM controls a microchip controller which manages electricity or DC voltage to each LED, enabling control of the color, intensity, effects, patterns such as fading and flashing, etc. produced by the LEDs. Unlike the static lighting strings, which provide continuous aesthetic lighting for the stacked grid members, the stacked grid members including the ICM-enabled LED light strings may combine to form a localized mesh network and provide changing light patterns or intensities between the stacked grid members. In some embodiments, at least one lighting member in a system of stackable and connectable decorative light assemblies is ICM-enabled to allow all of the lighting members to be controlled using a single ICM hub connection. In other embodiments, each stacked grid member will have a separate ICM-enabled LED light string which connects wirelessly to a central controller either locally or remotely from the location of the grid members. In some embodiments, the ICM will include a processor configured to detect the vertical position of each grid member relative to the base. In some embodiments, an ultrasonic sensor may be utilized to determine the vertical positions of the grid members, interfaced with an Arudino microcontroller. This logic-based sequencing allows for “upward-spiraling” or “cascading” light animations that may be synchronized across the entire vertical height of the pole or tree. Such arrangements will allow for synchronized control of the LED light strings to create various effects, animations, and programmable shows. In some embodiments, the lighting members may be programmed to sync with music or to other smart lighted decorations such as stars and wreaths.

FIG. 13 is similar to FIG. 5, except in FIG. 13 the decorative lighting member 523 mounted to grid member 500 from the inside is a string of LED lights incorporating an LED light controller system which includes an LED microcontroller or main processing unit 1000 (e.g. Arduino, ESP32, or dedicated IC) electrically connected to the lighting member 523 and which processes inputs and sends control signals to the individual LEDs 521. The LED microcontroller 1000 is shown in FIG. 13 as a separate control box but may alternatively be built into the plug, a battery control box, or connected to the LEDs by another suitable arrangement. LED microcontroller 1000 also includes wireless transceiver device 1002, and a power supply is connected to a 120 VAC outlet by plug 125, which power supply converts high voltage AC to a suitable low voltage DC (such as 5V, 12V or 24V) to power the LED strip, or alternatively the LED strip will receive power from a local source (e.g. battery power, solar power, etc.) Wireless transceiver device 1002 enables the LED micocontroller 1000 to connect to an input device or controller interface such as remote control 1004 for remotely controlling the LED lights 521 by communicating through a wireless communications system such as Bluetooth 1006, or another wireless system such as WiFi or Zigbee. Microcontroller 1000 also may include a logic level shifter or transistor circuit to boost low-voltage data signals (3.3V) to 5V needed for reliable LED operation with 5V LED protocols. Suitable wiring components such as JST connectors, terminal blocks, and wiring linking the power, controller and LEDs are also provided.

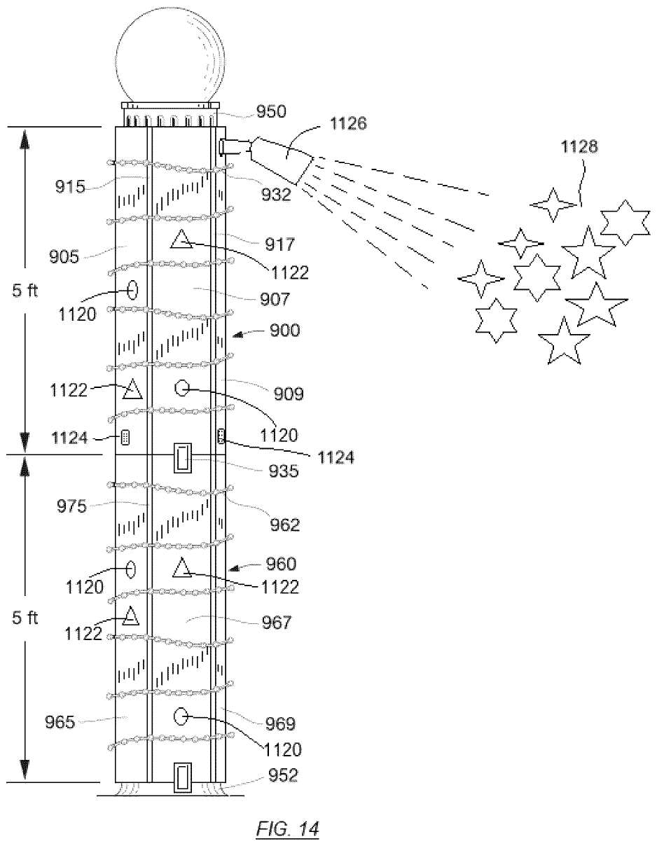

In some embodiments, the decorative lighting assembly may incorporate additional features such as ambient light sensors or photodetectors and Passive Infrared (PIR) motion sensors, which in some embodiments may be integrated directly into the semi-flexible grid substrate. FIG. 14 is similar to FIG. 12 except additionally illustrating several further features, including ambient light sensors 1120 mounted on an outer surface of the stiffening sections or panels 905 and 907 of the stacked grid members 900 and 960, which are secured around lamp post 950. The ambient light sensors 1120 in some embodiments are either hardwired or wirelessly connected to the lighting strings 932 and 962 and the LED controller, or to the user control. The ambient light sensors 1120 will continually measure the surrounding ambient light intensity and may be configured to adjust the light intensity of the LED lighting members accordingly to improve their visibility, save energy or extend battery life, and enhance overall visual comfort.

Also shown in FIG. 14 are several PIR motion sensors 1122 mounted in a spaced apart relationship on the stiffening members or panels 905 and 907 of stacked grid members 900 and 960. PIR motion sensors 1122 are also connected to the LED controller enabled light strings 932 and 962. Motion sensors 1122 will enable the lighting assembly and system to be programmed to transition, for example, from decorative low-intensity lighting to high-intensity security lighting upon detecting motion.

In addition, speakers 1124 are shown connected to stiffening members or panels 905 and 909 in FIG. 14, which speakers 1124 may in some embodiments be mini or micro speakers which in some embodiments are either hardwired or wirelessly connected to the LED light controller or the hand controller to provide synchronized music with the light display. Also shown mounted to panel 909 of grid member 900 in FIG. 14 is projector 1126, which in some embodiments is an outdoor laser light projector for projecting localized spotlights or decorative laser light displays patterns such as stars 1128 on to a wall, ground surface, or the like. In some embodiments, the laser light display may be synchronized both with music from the speakers 1124 and with lighting members 932 and 962.

In addition to the grid members of the present invention being used to support decorative lighting members and provide a decorative lighting assembly and system, in some embodiments, the stacked grid members may also be utilized as a “utility grid” for vertical structures. For example, the grid members may be configured to support one or more non-lighting member decorative attachments or specialized decorative add-on modules. A mechanical interface may be provided on the grid members for mounting the non-lighting member attachments to the grid members, which attachments may include but are not limited to seasonal figurines, wreaths or other three-dimensional objects, as well as flags, signs, advertising banners, and a wide range of other attachments. In some embodiments, the mechanical interface may comprise a snap-fit type connection for joining the non-lighting member attachments and the grid members, although other suitable connection or support devices including but not limited to hooks, clips, ties, adhesives, hook-and-loop fasteners, etc. may also be utilized which best support the particular non-lighting attachments.

FIG. 15 illustrates one snap-fit connection or mechanical interface utilizing a simple cantilever type snap joint 1130 including a protruding beam 1132 which is secured to the non-lighting member attachment 1134 (i.e. wreath shown in a side view) and a receiving part 1136 which is secured in or to the face of the grid member 1138. Beam 1132 may be straight or tapered and includes an enlarged head portion 1140 which is tapered at a forward angle on its entrance side and substantially perpendicular to the beam axis on its exit side. Upon being orthogonally inserted in opening 1142 in receiving part 1136, beam 1132 is deflected slightly downwardly (as oriented in the Figure) , and upon being fully inserted, the snap fit is actuated and beam 1132 is secured in opening 1142 in a manner familiar to those skilled in the art. The snap fit joint components may be made of any suitable material such as ABS plastic, metal nylon, or polypropylene having appropriate dimensions and mechanical properties required to support the non-lighting member attachment, in order to withstand repeated attachment and detachment of the non-lighting member attachments where they are detachable, as well as being temperature resistant. It will be understood that this cantilever type snap joint is merely illustrative, and other types of snap joint mechanical fasteners such as a ball and socket snap joint, perimeter snap-in or snap-over joint, as well as other fastener arrangements may be utilized. In some embodiments, one or more of the non-lighting member attachments may be permanently engaged to the grid members by the snap-fit connection, while in other embodiments may be detachable and the non-lighting member attachments are interchangeable. It will be understood that by “non-lighting member attachment” that the decorative attachments 1134 are not merely a string of lights, and furthermore that these attachments themselves may be both illuminating and non-illuminating decorations. An array of non-lighting member attachments can be secured to the grid members in order to customize the decorative display, similar to how one decorates a Christmas tree. The decorations that illuminate in some embodiments will plug into a power source provided on the panels or grid members, or may be plugged into a separate power source.

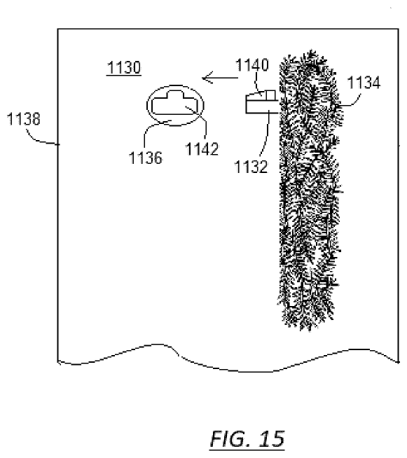

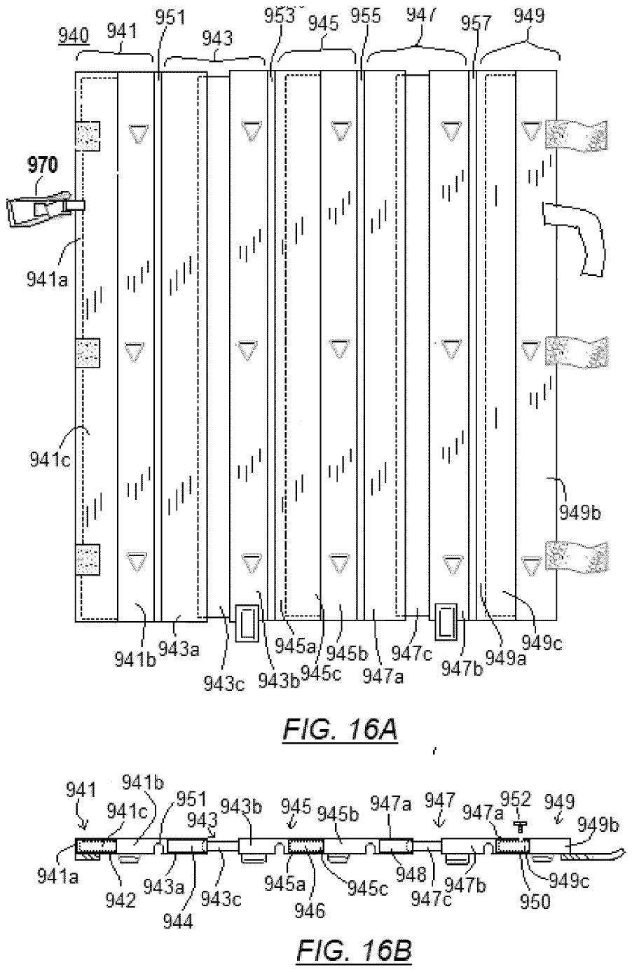

FIGS. 16a and 16b, which will now be discussed concurrently, illustrate another embodiment of the grid members of the present invention, which embodiment is similar to the previous embodiment described with respect to FIGS. 9 and 10 in that grid member 940 includes multiple thick, more rigid vertical stiffening sections 941, 943, 945, 947 and 949 which are connected by comparatively thin and flexible hinge members 951, 953, 955, and 957, respectively. In order to accommodate a wider variety of vertical structures, the vertical rigid stiffening sections 941, 943, 945, 947, and 949 of the grid member 940 are configured to be width adjustable, or horizontally expandable. This allows the width of the rigid sections of the grid member 940 to be customized to fit vertical structures having smaller or larger circumferences or perimeters, making the overall decorative lighting system more versatile. In some embodiments, as shown in FIGS. 16a and 16b, the rigid sections are configured to be telescoping or to slide within one another, while in other embodiments the rigid sections may slide relative to each other, or be width-adjustable using another structural arrangement such as by adding further panels to the grid member (similar to table leaves), or by certain portions folding in an accordion-like fashion. The adjustable width of the thick or rigid vertical sections in some embodiments allows the decorative lighting assembly to fit comfortably around vertical structures ranging from a 4-inch signpost to a 24-inch trunk without compromising the structural integrity of the vertical thicker “stiffening sections.” Each of the vertical stiffening sections 941, 943, 945, 947, and 949 of grid member 940 is configured to be horizontally expandable or width-adjustable. In some embodiments, some but not all of the stiffening sections may be expandable. In FIGS. 16a-b, vertical stiffening sections 941, 945 and 949 are shown in a telescoped or “non-expanded” position, while vertical stiffening sections 943 and 947 are shown in an extended or expanded position. Each of the stiffening sections 941, 943, 945, 947, and 949 includes a first vertical section and a second vertical section aligned side-by-side with the first vertical section. Stiffening section 941 includes first vertical section 941a and second vertical section 941b; stiffening section 943 includes first vertical section 943a and second vertical section 943b; stiffening section 945 includes first vertical section 945a and second vertical section 945b; stiffening section 947 includes first vertical section 947a and second vertical section 947b; and stiffening section 949 includes first vertical section 949a and second vertical section 949b. Slots 942, 944, 946, 948, and 950 (FIG. 16b) are formed in first vertical sections 941a, 943a, 945a, 947a, and 949a, respectively, which slots open towards second vertical sections 941b, 943b, 945b, 947b, and 949b. Second vertical sections 941b, 943b, 945b, 947b, and 949b also include a telescoping portion 941c, 943c, 945c, 947c, and 949c configured to slide in slots 942, 944, 946, 948, and 950, respectively. Stiffening sections 943 and 947 are in an expanded configuration such that telescoping portions 943c and 947c are substantially extended out of or removed from slots 944 and 948 in first vertical sections 943a and 947a, respectively, in order to increase the width of vertical stiffening sections 943 and 947.

A mechanical stop may be provided on the telescoping portions to prevent the telescoping portions 941c, 943c, 945c, 947c, and 949c from sliding completely out of the slots 942, 944, 946, 948, and 950, respectively. In some embodiments, rails, rollers or other guides may be provided in slots 942, 944, 946, 948, and 950 on which the telescoping portions 941c, 943c, 945c, 947c, and 949c are slidable. In addition, a locking mechanism is preferably provided as part of the expandable assemblies in order to secure the first and second vertical sections in a desired telescoped or expanded position, or in some embodiments any number of intermediate positions. In some embodiments, the locking mechanism may be but is not limited to a compression-type locking mechanism. For example, as shown in FIG. 16b with respect to stiffening section 949, one or more threaded apertures may be provided in the rear wall of first vertical section 949a extending into slot 950 through which a threaded member 952 is inserted which compresses the telescoping portion 947c against the inner wall of the slot 950, securing the telescoping portion 947c by a friction fit. In other embodiments, a ball locking pin may extend into aligned apertures in the telescoping portion to secure the telescoping portion. In addition, in some embodiments, a variable-diameter ratchet mechanism 970 may be integrated into the grid member to secure the grid member around the vertical structure at a selected expanded or contracted width.

The horizontally expandable and geometrically adaptable grid members can be better configured to correspond with the dimensions of the vertical structure the decorative lighting system is to be secured around. Thin hinge members 951, 953, 955, and 957 are configured to articulate, particularly around corners where they serve as articulating corner hinges, which is particularly useful in non-cylindrical applications (e.g., square architectural pillars) so the grid members can conform closely to the shape of the object. In some embodiments, the thin hinge members 951, 953, 955, and 957 may be configured as specialized “living hinges” or pivot points which can be spread open and then when released will “spring” back to their original position, which may be located between lighting nodes. These allow the grid to maintain a flush profile against flat surfaces and 90-degree corners, ensuring the “glide-up” or stacking installation method remains functional on modern building supports.

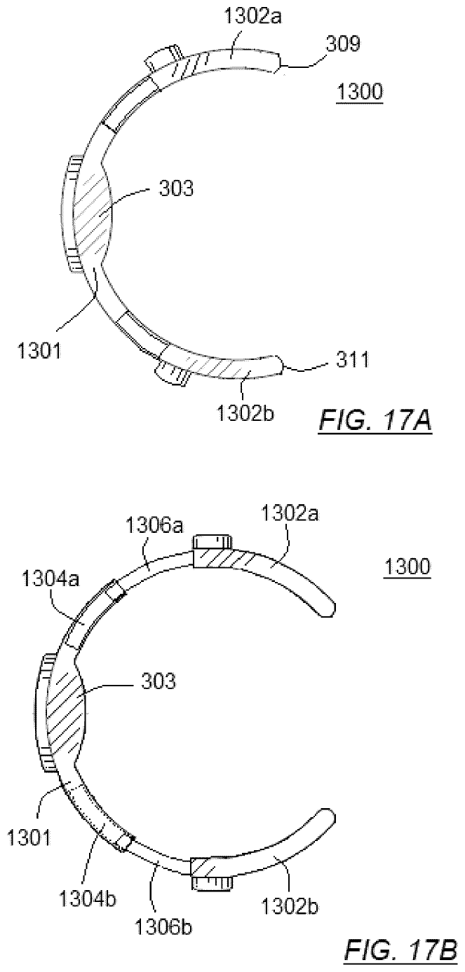

FIGS. 17a and 17b illustrate another embodiment of the grid members of the present invention, which is similar to the embodiment shown in FIG. 3 wherein the grid member is formed as an open flexible loop 301 having ends 309 and 311, and includes a vertical rigid section 303 that is unistructurally formed as part of the grid member. In the present embodiment, however, the open flexible loop grid member 1300 has a center section 1301 and opposite extendable end sections 1302a and 1302b. More particularly, center section 1301 includes slotted openings 1304a and 1304b on its outer ends in which telescoping portions 1306a and 1306b, respectively, of end sections 1302a and 1302b are slidable. Additional unistructural or insertable rigid sections may be provided on the extendable end sections 1302a and 1302b. Similar to FIG. 5, the grid member 1300 may have a natural “living spring” C-shaped footprint that naturally conforms to a cylindrically shaped object such as a tree or post, but can also be adapted to better fit objects of different diameters. In some embodiments, the center section 1301 may be expandable in a similar manner to end sections 1302a and 1302b, either alone or in combination with the end sections.

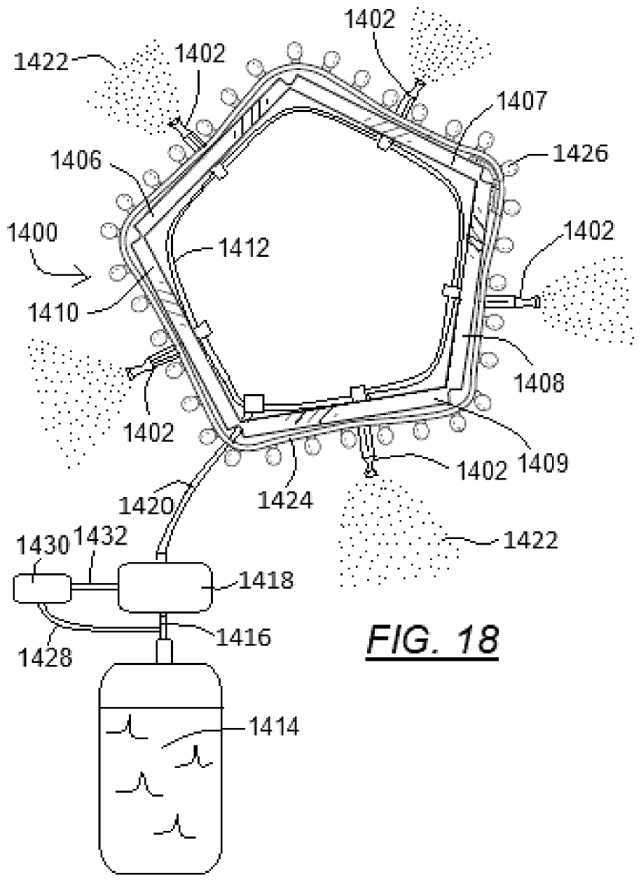

In another embodiment, the semi-flexible grid members or sections may be utilized to support additional devices such as a water misting system including atmospheric misting channels. In these embodiments, the semi-flexible grid members may be manufactured with an integrated internal lumen or a clip-on conduit system for fluid delivery. In FIG. 18, a top view of a decorative light assembly 1400 is shown having misting nozzles 1402 secured to the grid member panels at regular intervals. More particularly, nozzles 1402 are attached extending outwardly from the outer surface of the grid member panels 1406, 1407, 1408, 1409, and 1410, although in other embodiments may be flush with the outer surface of the grid members or placed in another less conspicuous position. Nozzles 1402 are connected to a conduit system 1412, shown extending along an inner surface of the grid member, which conduit system 1412 in use is connected to a pressurized fluid source such as reservoir 1414 from which water is fed in line 1416 to pressure pump 1418, and then by another line 1420 which connects to conduit system 1412. Nozzles 1402 therefore provide a cooling water mist or fog 1422 into the surrounding environment. Reservoir 1418 can be different sizes depending upon whether the installation is temporary or more permanent. Assembly 1400 therefore can provide localized evaporative cooling or “self-cleaning mists” which may be desirable in hot and/or high-traffic outdoor areas such as patios, or to reduce odors. Lighting member or string 1424 with lights 1426 is also shown secured around the grid member panels. In at least some installations, the misting nozzles 1402 may be more desirably positioned on a second or third, upper or top stacked present invention decorative light assembly so that the nozzles less obtrusive and are out of the way, and also the spray or mist 1422 will tend to spread out more in the air. In some other embodiments, in addition to spreading a cooling mist, the misting system may also be configured to diffuse fragrances or signature scents to enhance mood and sensory experience. This may include connecting a fragrance manifold 1430 between the water supply tank 1414 and pressure pump 1418 via bypass lines 1428 and 1432, as shown in FIG. 18. A separate fragrance misting system may also be provided. The misting system may be controlled by a user interface via Bluetooth or otherwise incorporated with the grid member lighting system.

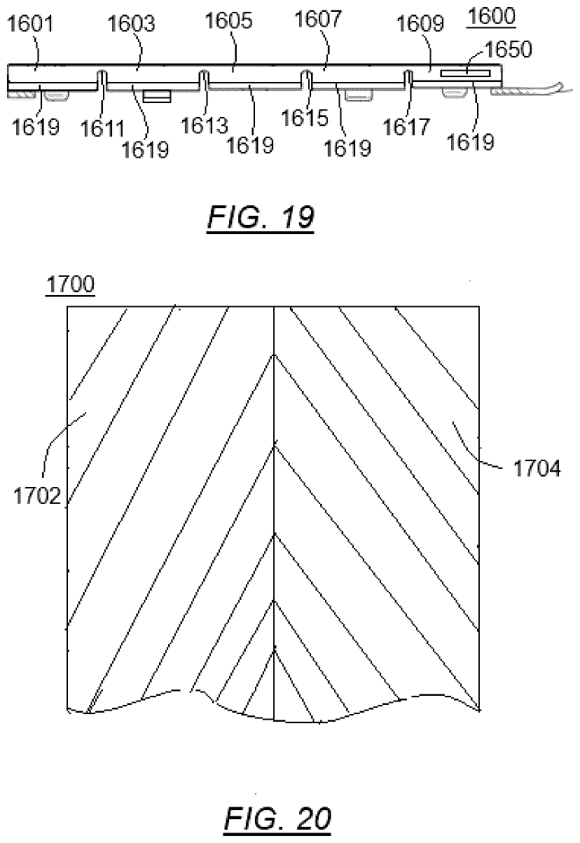

FIG. 19 illustrates a side view of another alternative embodiment of the grid members, namely grid member 1600. Grid member 1600 is similar to the grid member 900 shown in FIG. 10, as it includes stiffening sections 1601, 1603, 1605, 1607, and 1609 connected by comparatively thin sections 1611, 1613, 1615, and 1617. In addition, the exterior-facing surfaces of stiffening sections 1601, 1603, 1605, 1607, and 1609 are laminated with flexible thin-film photovoltaic (PV) cells 1619. Together, all of the PV cells 1619 disposed on the grid members 1600 form a solar array. Energy harvested by the PV cells may be stored in thin-profile lithium-polymer batteries. In some embodiments, the batteries may be integrated into the “stiffening sections” of the grid members, as shown in FIG. 19A at 1650 in vertical section 1609. This allows for a completely wireless, self-powered installation that does not require an external AC power source. In other embodiments, the batteries may be stored separately.

In still other embodiments, at least a portion of the grid member substrate may be composed of a shape-memory polymer (SMPs) material, which is a “smart” material that can be deformed and fixed into a temporary shape, then triggered by an external stimulus-typically heat, but also light, electricity, or solvent-to return to its original, permanent shape. FIG. 20 illustrates diagrammatically a portion of one of the flexible grid members 1700 wherein portion 1702 is comprised of a conventional material and portion 1704 is comprised of an SMP material. In some embodiments, for example, upon removal from packaging and exposure to ambient heat or a specific electrical trigger, the grid members may be “programmed” to automatically constrict to a pre-set diameter, facilitating a snug, tool-free fit around a vertical object such as a pole. Suitable SMP's for use with the grid members 1700 may include thermoplastic polyurethanes, semi-crystalline polymers, liquid crystalline elastomers, shape memory composites and crosslinked polymer networks. Separate stiffening or rigid vertical sections could be integrally incorporated into the shape-memory polymer portion or provided as a separate attachment.

Although particular embodiments of the invention have been described in detail herein with reference to the accompanying drawings, it is to be understood that the invention is not limited to those particular embodiments, and that various changes and modifications may be affected therein by one skilled in the art without departing from the scope or spirit of the invention as defined in the appended claims. Although particular embodiments of the invention have been described in detail herein with reference to the accompanying drawings, it is to be understood that the invention is not limited to those particular embodiments, and that various changes and modifications may be affected therein by one skilled in the art without departing from the scope or spirit of the invention as defined in the appended claims.

What is claimed is:

1. A decorative lighting system for mounting to a vertical structure, comprising:
a plurality of stackable and connectable decorative lighting assemblies, each of said decorative lighting assemblies including a semi-flexible grid member configured to at least partially wrap around the vertical structure, and having a rigid vertical section, and an attachment mechanism for vertically connecting at least two of the grid members of the decorative lighting assemblies together in a vertically stacked position;
at least one lighting member either permanently or removably attached to the grid member, the lighting member comprising a plurality of light-emitting diodes (LEDs);
an LED controller electrically connected to the at least one lighting member for controlling the LEDs; and
a wireless transceiver in communication with the LED controller, configured to wirelessly connect the LED controller to a local or remote controller.

2. The decorative lighting system of claim 1 wherein the LED controller comprises an Integrated Control Module (“ICM”) connected to the LED light string and further comprising a processor within the ICM configured to detect the vertical position of the grid member relative to a base or to other of the vertically stacked grid members.

3. The decorative lighting system of claim 1 further comprising at least one sensor integrated into our mounted upon one of the semi-flexible grid members, wherein the sensor is in communication with the LED controller.

4. The decorative lighting assembly of claim 3, wherein the at least one sensor comprises an ambient light sensor configured to measure surrounding light intensity, and wherein the LED controller adjusts the output intensity of the LEDs based on data from the ambient light sensor.

5. The decorative lighting assembly of claim 3, wherein the at least one sensor comprises a Passive Infrared (PIR) motion sensor, and wherein the LED controller is programmed to transition the LEDs from a decorative low-intensity lighting state to a high-intensity security lighting state upon the detection of motion.

6. The decorative lighting assembly of claim 1, further comprising a mechanical interface disposed on an outer surface of the grid members for securing a non-lighting attachment to the grid member.

7. The decorative lighting assembly of claim 6 wherein the mechanical interface comprises a cantilever snap-fit type connection.

8. The decorative lighting system of claim 5 wherein said rigid vertical section is a rigid vertical section selected from the group consisting of an elongated flat piece, a rod, and a spine.

9. The decorative lighting system of claim 1 wherein said grid members are horizontally expandable for adjustable mounting to the vertical structure.

10. The vertical lighting system of claim 1 wherein the grid member further comprises a plurality of vertical thick sections connected by thin flexible hinge sections, wherein at least one of the vertical thick sections is horizontally expandable and includes a first vertical section and a second vertical section, the first vertical section having a slot opening towards the second vertical section, and the second vertical section including a telescoping portion slidably secured within the slot of the first vertical section, allowing the overall width of the grid member to be selectively adjusted.

11. The decorative lighting system of claim 1 wherein each of said grid members further comprises a flat sheet with a plurality of vertically foldable hinges to enable flat storage and to enable flexible wrapping about said vertical structure.

12. The decorative lighting system of claim 1 wherein each of said grid members has a natural living spring C-shaped footprint that can be spread open and then released to spring back to its original position around a vertical structure, and wherein the grid members are horizontally expandable.

13. The decorative lighting system of claim 11 wherein the grid members include a center section and a pair of opposite extendable end sections.

14. The decorative lighting system of claim 1 further comprising a variable-diameter ratchet mechanism integrated into the grid member to secure the grid member around the vertical structure at a selected expanded or contracted width.

15. The decorative lighting system of claim 1 further comprising a water misting system integrated into the decorative lighting system including at least one misting nozzle mounting to one of the stacked assemblies.

16. The decorative lighting system of claim 1 further comprising a photovoltaic (PV) solar layer disposed on an outer surface of the grid members of at least one of the decorative lighting assemblies.

17. The decorative lighting system of claim 3 further comprising at least one battery integrated into a stiffening section of the grid member to power the ICM and lighting member.

18. The decorative lighting system of claim 1 further comprising a light projection module connected to the grid member of at least one of the decorative lighting assemblies and configured to project localized spotlights.

19. The decorative lighting system of claim 1 wherein at least a portion of the grid member further comprises a shape memory polymer (SMP) material.
